(19) United States
(12) Patent Application Publication
(10) Pub. No.: US 2004/0057064 A1
(43) Pub. Date: Mar. 25, 2004

(54) Method to edit a document on a peripheral device

(76) Inventor: Gary Glen Stringham, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/247,884

(22) Filed: Sep. 20, 2002

(51) Int. Cl. G06F 9/00; H04N 1/387

(52) U.S. Cl. 358/1.13; 358/452

(57) ABSTRACT

A multi-function peripheral (MFP) with the ability to edit documents preferably includes a scanner for scanning a document to produce an electronic file, a processor for editing the electronic file, a user interface for controlling the editing of the electronic file, and a print engine for printing an edited document from the electronic file.

### BACKGROUND OF THE INVENTION

Traditionally, office environments have been provided with photocopiers, printers, scanners, and facsimile machines. Modem technology has allowed the integration of these devices to provide a single machine that can make exact copies of hard copy documents, print documents from electronic data, scan hard copy documents into an electronic form, and receive and send facsimiles. A machine that combines two or more of these functions may be referred to as a multi-function peripheral (MFP).

As used herein and in the attached claims, an MFP is defined as a device that includes the functionality of two or more of the following devices: a photocopier, a scanner, a printer or a facsimile machine.

Users frequently desire to edit a previously printed document. In many cases a user has only the hard copy document and does not have access to an electronic copy of the document. In other instances, the user may have an electronic copy of the document, but does not have immediate access to a computer on which the document can be edited. These scenarios are particularly common on business trips, or when the user is away from home or office.

If the user wants to edit a document, but only has a hard copy, Optical Character Recognition can be used to create an electronic, editable version of the hard copy document. Optical Character Recognition (OCR) technology currently exists that allows printed or written characters to be scanned from a hard copy document and translated into character codes producing an electronic text file. This text file may then be opened and edited with standard word processing programs. Once the document has been edited, it can be re-printed in its edited form to provide an edited hard copy.

While OCR can allow a user to eventually make edits to a hard copy document, in many cases the user may not have access to a scanning device, an OCR program, and a computer that will allow the user to edit the document. Again, this may particularly be the case when the user is traveling and away from home and office. In such a case it may be difficult and inconvenient to edit an original document in a timely manner.

### SUMMARY OF THE INVENTION

In one of many possible embodiments, the present invention provides an MFP for editing documents. The MFP preferably includes a scanner for scanning a document to produce an electronic file, a processor for editing the electronic file, a user interface for controlling the editing of the electronic file, and a print engine for printing an edited document from the electronic file.

Additional advantages and novel features of the invention will be set forth in the description which follows or may be learned by those skilled in the art through reading these materials or practicing the invention. The advantages of the invention may be achieved through the means recited in the attached claims.

### BRIEF DESCRIPTION OF THE DRAWINGS

The accompanying drawings illustrate various embodiments of the present invention and are a part of the specification. The illustrated embodiments are examples of the present invention and do not limit the scope of the invention.

FIG. 1 is a perspective view of a specialized MFP according to an embodiment of the present invention, an original document, and a revised document.

FIG. 2 is an illustration of a first embodiment of a system according to the present invention.

FIG. 3 is a perspective view of an original document, specialized MFP, and revised document illustrating a method of operating the system illustrated in FIG. 2 in accordance with principles of the present invention.

FIG. 4 is a flowchart illustrating a method of operating the system illustrated in FIG. 2 in accordance with principles of the present invention.

FIG. 5 is a flowchart illustrating a second method of operating the system illustrated in FIG. 2 in accordance with principles of the present invention.

Throughout the drawings, identical reference numbers designate similar, but not necessarily identical, elements.

### DETAILED DESCRIPTION OF EMBODIMENTS OF THE INVENTION

In one embodiment, the present invention provides a system and method of editing a document on a multi-function peripheral (MFP). The MFP implements a method and provides a system that allows a user to edit and reformat an original document and print the revised document. Moreover, the system may allow a user to scan a document onto an MFP after which it may be automatically converted to a digital text file. The user may edit the digital text file using a user interface after which the document may be re-aligned for aesthetic presentation and printed out with the completed revisions.

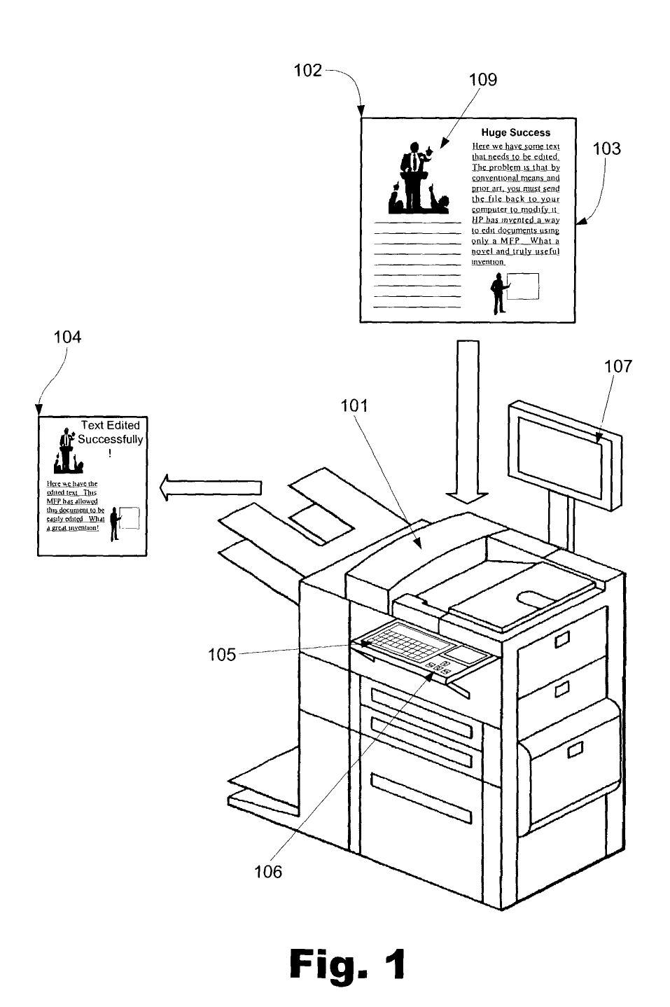

Using the drawings, the present invention will now be explained. FIG. 1 shows an original document (102). As used herein, the original document (102) may be a paper copy, transparency, or any other hard copy document. As shown in FIG. 1, the original document (102) may include both textual elements (103) and graphic elements (109). The graphics (109) may be, for example, a photograph, graph, illustration, drawing, etc. The present invention may be used to allow selected text (103) on the original document (102) to be edited on the MFP (101). Additionally, the graphics (109) may be edited

The MFP (101) of FIG. 1 includes a scanner and OCR technology. Consequently, the original document (102) can be scanned by the MFP (101). The OCR software on the MFP (101) then converts the electronic data produced by the scan into an editable electronic document. The MFP (101) also has user interface elements that allow the user to view and revise the original document (102) by accessing the editable electronic file produced by the OCR software. The user interface also allows the user to visually verify those changes made to the original document.

The MFP (101) preferably has an alphanumeric keyboard (105) for editing selected text (103) and for adding additional text, symbols, and numbers to the original document (102). The MFP may also have cursor keys (106) that assist the user in making edits to the original document (102). The cursor keys (106) may allow the user to scroll through files, mark selected text, and control other functions of the MFP (101). The alphanumeric keyboard (105) and cursor keys (106) may allow functionality similar to that available on most personal computers (PC) and word processors.

Preferably the user interface includes a display panel (107). The display panel (107) allows the digital files on the MFP (101) to be displayed allowing the user to visual verify those changes made to the digital file, i.e., the original document (102), using the alphanumeric keyboard (105) and cursor keys. The display panel (107) assists the user in editing the original document (102) so that a revised document (104) can be produced to the user's satisfaction.

Alternatively, the user interface in an embodiment of the present invention could include a monitor, touch screen display, mouse, trackball, light pen, or any other mechanism that allows the user to send and receive information so as to control and verify the process of editing the original document (102).

The MFP (101) of FIG. 1 also includes a print engine capable of printing a hard copy document from electronic data. Thus, the file that once represented the original document (102), but which has been edited through the user interface of the MFP (101) can be printed to produce a revised hard copy document (104). Consequently, the MFP (101) has components that allow a user to edit an original document (102) and then print out the revised document (104) on a desired print medium. The print medium may be defined as any size or color of paper, transparency, or other medium that allows ink or toner to adhere to the surface. As used herein, the varying print mediums may be referred to collectively as paper, due to the present extensive use of paper in copying systems. The end result is the revised document (104) that has also been automatically reformatted and printed on an available user-specified print medium.

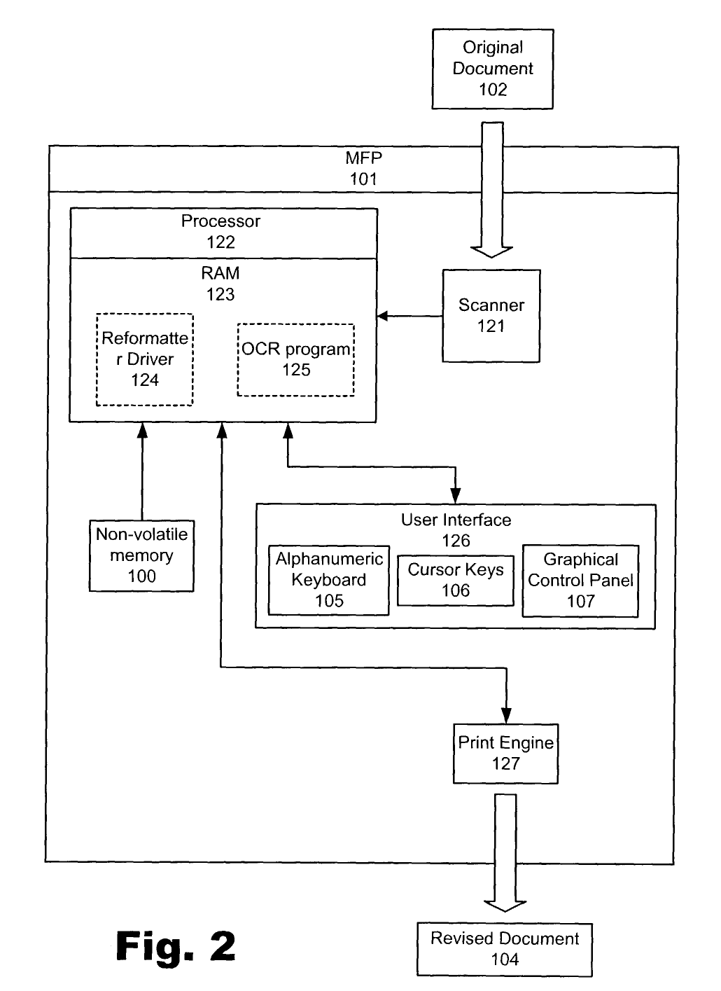

FIG. 2 is a block diagram of the internal and external components of an MFP according to an embodiment of the present invention. FIG. 2 illustrates an MFP (101) specialized for the purpose of receiving an original document (102), scanning that original document to create an electronic version of the document, allowing a user to edit and automatically reformat the original document (102), and then print the revised document (104) in hard copy form.

In the embodiment of FIG. 2, the MFP (101) includes a scanner (121) that allows the original document (102) to be scanned and converted into a digital file. The scanner (121) may or include any device or process that allows text, graphics or other images to be analyzed and converted into a digital file. The creation of the digital file produced by the scan allows the original document (102) to be displayed and edited by the MFP, or converted to various other types of digital files for use on a standard computing device. Scanned digital files may be in a variety of formats including, but not limited to, bitmap, graphics interchange format (GIF), or joint photographic experts group (JPEG) file format.

A processor (122) is one of the internal elements of the MFP (101) allowing the computing operations needed to revise the electronic file that represents the original document (102). The processor (122) is the central processing unit within the MFP (101) and contains logic circuitry that performs or executes the instructions that allow all the operations of the MFP. The firmware or software for operating the MFP (101) will be stored in non-volatile storage (100) and loaded into random access memory (RAM) (123) for execution by the processor (122). The firmware or software of the MFP (100) may include an operating system and a number of applications that run under the operating system, such as an OCR program (125) and a reformatter driver (124). The operating system may work, as executed by the processor (122), to control the applications and memory as described below. The processor (122) may coordinate the computing elements of the MFP (101) by allocating memory space, time for each process, and processing the application programs.

As noted above, one of the application programs preferably provided within the MFP (101) to allow a document to be revised is an optical character recognition (OCR) program (125). An OCR program (125) may allow text contained in a scanned-in image or digital file (e.g., BITMAP, GIF, JPEG) to be translated into a file containing character codes such as American Standard Code for Information Interchange (ASCII) or Unicode. The character codes used by ASCII may be particularly useful in the OCR program (125) because ASCII is the most common format for text files in computers, word processing programs, and other electronic devices.

In an ASCII file, each alphabetic, numeric, or special character is represented with a 7-bit binary number. ASCII files may be easily stored in RAM (123) or non-volatile memory (100) and accessed by the processor (122) allowing the user to edit the ASCII text file. Preferably the OCR program will recognize graphics contained in the original document (102) and represent them in the newly created text file in essentially the same spatial location as in the original document (101). Because of the practical application of the present invention in editing text, the file produced by the OCR program will be referred to as a text file even though it may contain graphic elements as well.

A second program that may be stored in non-volatile memory (100) and loaded to RAM (123) for execution by the processor (122) is a reformatter driver (124). The reformatter driver (124) is a program or driver that takes a revised text file that is going to be printed and reformats it for a user-specified or available print medium. The reformatter driver (124) is used to reformat paragraphs, page boundaries, graphics, text, etc. In most cases the reformatter driver (124) allows the original document (102), or an edited text file to be reformatted so that the final printed document is aesthetically acceptable to the user. The reformatter driver (124) may be particularly useful when a desired paper type is not available in the MFP (101), or when changes to a file have changed the way an original document (102) appears. Some or all of the reformatter driver (124) functions maybe automatic, while some or all of those functions may be user-controlled through the user interface (126).

Consequently, the MFP (101) illustrated in FIG. 2 preferably includes a user interface (126). As described above, the user interface (126) preferably includes an alphanumeric keyboard (105), cursor keys (106), and/or a display panel (107) or any of the alternatives previously mentioned.

The user interface (126) allows the user to edit a text file created after the original document (102) has been scanned by the scanner (121) and converted to a text file by the OCR program (125). The user interface (126) also allows the user to view the edited and reformatted files on the display panel (107) to approve the files before printing. The user interface (126) preferably also allows the user to efficiently control the MFP (101) functions and perform the desired revisions to the original document (102) to obtain a suitable revised document (128). The user interface (126) may similarly allow the user to select the desired print medium for the revised document (128) and make other necessary decisions in the editing process of the MFP (101). The computing operations allowed by the user interface (126) are preferably comparable to those available on most word processors and personal computers.

The MFP (101) of FIG. 2 also includes a print engine (127). The print engine (127) preferably contains all of the physical and electrical components necessary to print an image onto a sheet of print medium. The print engine (127) may be, for example, a laser printer, an inkjet printer, or any other type of print engine. The print engine (127) receives the revised text file from the processor (122). The print engine (127) will prepare the revised file to be rendered on the print medium, e.g., a specified paper type. This process may include converting the revised file received from the processor (122) into a set of command codes or a print job file that enables the revised file to be accurately translated for the physical printing process. It is important that the revised document (104) and corresponding text be correctly rendered on the selected paper type.

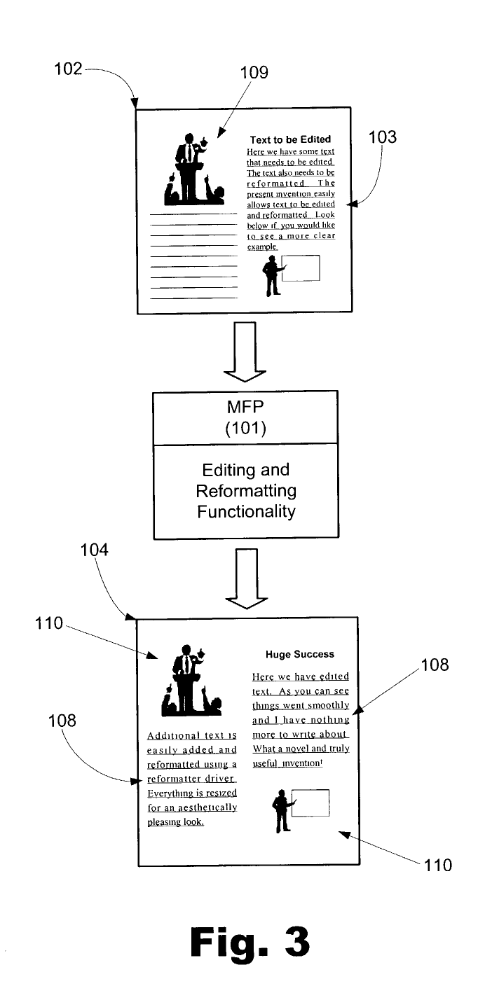

FIG. 3 is another description of the functionality of the MFP (101) of FIG. 1. Shown is an original document (102) with corresponding text (103) and graphics (109) that may need to be edited and/or reformatted. The text (103) and graphics (109) of the original document (102) may need to be edited or reformatted for a variety of reasons including misspelled words, missing text, a new paper size is desired for the information contained on the original document, etc.

The original document (101) may be edited on the MFP (101) using the included editing and reformatting functionality as described in connection with FIGS. 1 and 2 as embodiments of the present invention. FIG. 3 shows the revised document (104) and the corresponding text (108) that has been edited and/or reformatted and the graphics (110) that may have likewise been revised, i.e., resized, relocated, reoriented, etc. In some cases the original document graphics (109) may need to be resized to allow additional text (108) to be added, or the paper type may have changed necessitating a resizing of the included graphical elements (108). FIG. 3 shows an original document (102) and revised document (104) that illustrate such a case.

The following example may better demonstrate the usefulness of the present invention and the importance of a reformatter driver in the MFP (101). The example provided may be most useful in understanding possible scenarios used on the MFP (101), but is not indicative of the MFP (101) operation as explained in the varying embodiments included herein. Once the original document (102) has been received and the user has made the desired changes to create a revised file, the user may send a command to print the revised file on the same type of paper as the original document (102), for example letter-sized paper (8.5 inches×11 inches).

The job may then be sent to the print engine. While translating the revised file into a print job, the print engine notes the command to use letter paper. However, the print engine determines that there is no letter paper available in any of the MFP (101) trays or print medium supply areas. The print engine may then determine that the job should be printed on some other available print medium, e.g., executive paper. This determination may be made either via user intervention or via pre-programmed defaults.

The print engine can then send the revised file to the reformatter driver. The reformatter driver reformats the file to best accommodate the existing elements on the available print medium. For example, paragraphs and newly added text (108) may be adjusted so that the page margins and font sizes are maintained. The size of graphical objects may also be adjusted. The reformatter driver generates a new revised file formatted for the new print medium type. The reformatter driver then sends the new revised file back into the print engine's job stream. The new revised file is then processed by the print engine and the revised document (104) is printed.

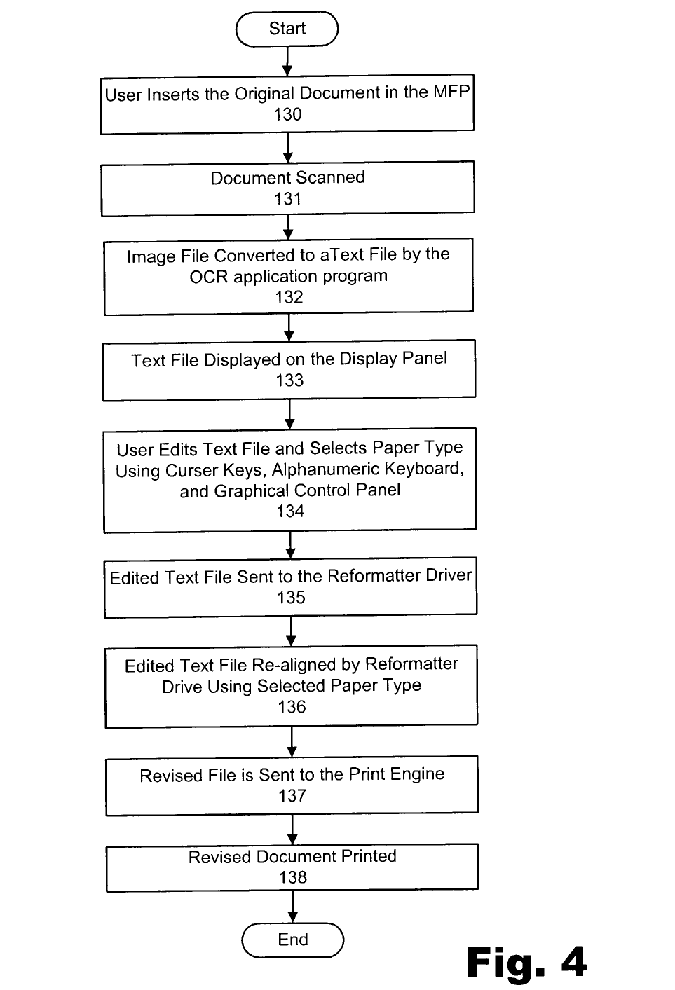

FIG. 4 is a flow chart illustrating a method of operating the system illustrated in FIG. 2 in accordance with principles of the present invention. As shown in the example of FIG. 4, the process begins when the user inserts an original document into the MFP (130) for scanning or copying.

The document is then scanned to generate a digital file representing the document (131). This digital file can then be processed by an OCR application to generate a text file for editing (132).

The text file is displayed on the display panel (133). The user can then edit the text file using the user interface of the MFP (134). When the editing is finished, the edited file may be reformatted with a reformatter driver (135) to accommodate the edits and/or any change in the size of the target print medium (136).

The revised file is then sent to a print engine (137). The print engine prints the document on a designated or available print medium (138).

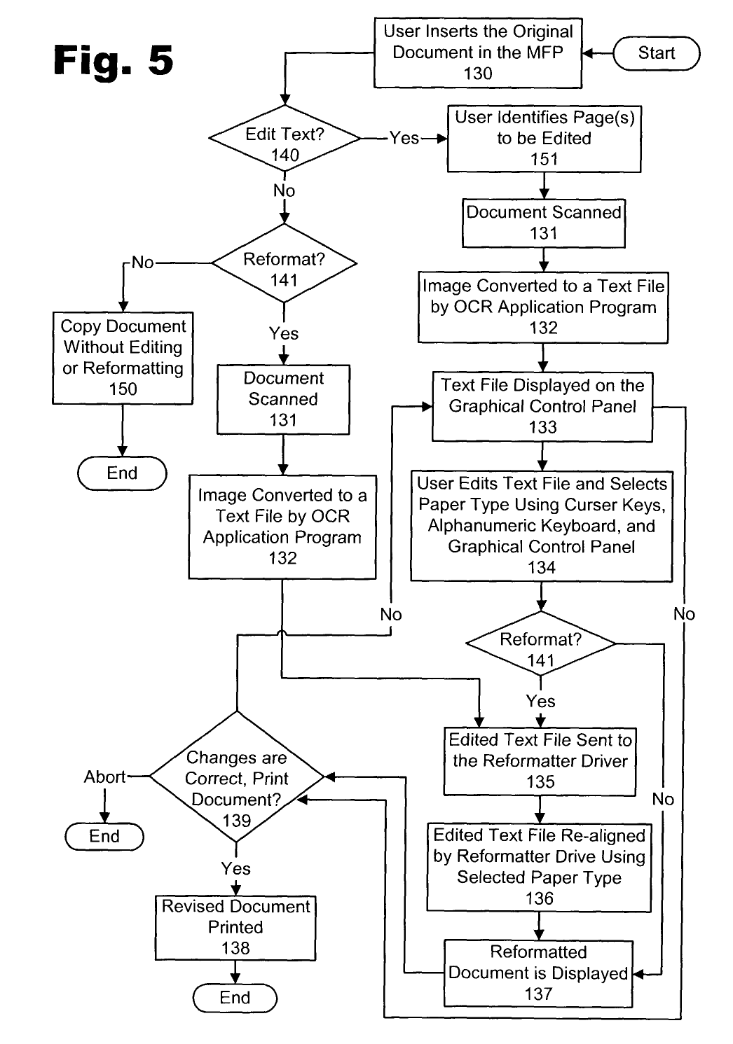

FIG. 5 is a flow chart illustrating a more detailed method of operating the system illustrated in FIG. 2. The method of FIG. 5 is similar in some respects to that illustrated in FIG. 4. As shown in the example of FIG. 5, the process begins when the user inserts an original document into the MFP (130) for scanning or copying.

The user may then be prompted through the user interface to indicate if the document is to be edited (140). If the user indicates that the document is to be edited and the document includes multiple pages, the user may be prompted to identify which page or pages of the document are to be edited (151). Only those pages that are to be edited need be converted to editable text by the OCR application. The other pages, assuming they are unaffected by the edits on a preceding page, can simply be scanned and duplicated without being processed by the OCR application. The existence of multiple pages can be determined by having the MFP feed a first sheet of the document preparatory to scanning or copying and then determining if additional sheets remain in the document feeder.

The document is then scanned (131) by the MFP and converted to a digital file as described above. The digital file may be an image file or any other file that may be processed by the OCR application program. The page or pages that have been identified for editing by the user are then converted into an editable text file by the OCR application (132). In other words, those portions of the digital file output by the scanner that correspond to the page or pages identified for editing are processed by the OCR application to generate an editable text file. If the document consists of only one page that is to be edited, or several pages, all of which are to be edited, the entire digital file will be processed by the OCR application into a text file. As described previously, the converted text file may include ASCII code or Unicode that describes the text and symbols contained in the original document. Preferably, graphics contained in the original document are passed through the MFP editing process without changing shape, resolution, or geographic location on the document, unless otherwise specified by the user or required by edits to the existing text, a change in print medium, etc.

The converted text file is then graphically translated onto the display panel where the text and graphics of the original document are displayed using the electronic file (133). The user may examine the electronic document using the display panel, edit the text and select a desired print medium type using the user interface, e.g., the alphanumeric keyboard, curser keys, and graphical control panel (134) of the MFP.

Once the user has satisfactorily edited the electronic document (134), the file may be sent to the reformatter driver (135). The edited text file can then be reformatted, if necessary, by the reformatter driver in response to user controlled settings, a designated print medium type, etc (136). After the edited text file has been reformatted (136), the revised text file is sent to the print engine (137). This may include recombining the edited pages with pages that were not edited or processed by the OCR application. The print engine prepares the revised text file for printing and prints the edited version of the document on a designated print medium (138).

Returning to the top of FIG. 5, if the user inserts an original document (130) and then responds by entering “no” when asked if the document should be edited (140), the user is preferably prompted through the user interface to indicate whether the original document should be reformatted (141). Reformatting may be desired if the document is to be printed or copied to a differently-sized print medium. If the user enters “yes,” the document is scanned (131) and then converted into a text file (132) that can be reformatted by the reformatter driver (135, 136).

The reformatted document can then be displayed in the user interface (137). At that point, the user may be queried whether the changes are correct, and if the reformatted file is approved for printing (139). If the user enters “yes,” the revised document will be printed (138). If the user enters “no,” the edited text file may be once again displayed on the display panel (133). The user may further edit the text file and/or select a print medium type (134). At this point, the process continues as previously described.

Additionally, when asked if the changes to the document are correct and whether the revised document is approved for printing, the user may elect to abort the process. This alternative is preferably presented to allow the user to exit the MFP editing process if the desired results are not achieved so that the user is not forced to print a revised document that they find unacceptable.

Returning to the top of FIG. 5, where the user is asked if the text of the input document is to be edited (140), if the user enters “no,” the user may then be asked if the original document is to be reformatted, e.g., for a different print medium that the original (141). If the user enters “no” again, the inserted document is simply copied without any editing or reformatting (150).

The preceding description has been presented only to illustrate and describe the invention. It is not intended to be exhaustive or to limit the invention to any precise form disclosed. Many modifications and variations are possible in light of the above teaching.

The foregoing embodiments were chosen and described in order to best illustrate principles of the invention and their practical application. The preceding description is intended to enable others skilled in the art to best utilize the invention in various embodiments and with various modifications as are suited to the particular use contemplated. It is intended that the scope of the invention be defined by the following claims.

What is claimed is:

1. A multi-function peripheral (MFP) for editing documents comprising:
a scanner for scanning a document to produce an electronic file;
a processor for editing said electronic file;
a user interface for controlling said editing of said electronic file; and
a print engine for printing an edited document from said electronic file.

2. The MFP for editing documents of claim 1, wherein said user interface comprises an alphanumeric keyboard.

3. The MFP for editing documents of claim 1, wherein said user interface comprises cursor keys.

4. The MFP for editing documents of claim 1, wherein said user interface comprises a touch screen for displaying information and receiving user input.

5. The MFP for editing document of claim 1, further comprising:
non-volatile memory for storing application programs; and
random access memory for loading said application programs for execution by said processor.

6. The MFP for editing documents of claim 5, wherein said application programs comprise an optical character recognition program.

7. The MFP for editing documents of claim 5, wherein said application programs comprise a reformatter driver.

8. The MFP for editing document of claim 5, further comprising an operating system stored in said non-volatile memory for controlling functions of said user interface and loading of said application programs.

9. A method of editing a document on a multi-function peripheral (MFP), said method comprising:
scanning said document with a scanning unit of said MFP;
producing an electronic text file representing said document;
editing said text file with a user interface of said multi-function peripheral to produce an edited text file; and
printing said edited text file.

10. The method of editing a document on an MFP of claim 9, further comprising reformatting said edited text file prior to printing said edited text file.

11. The method of editing a document on an MFP of claim 9, further comprising adding text to said text file.

12. The method of editing a document on an MFP of claim 9, further comprising rearranging graphic elements of said document represented in said electronic text file.

13. The method of editing a document on an MFP of claim 9, wherein said producing an electronic text file is performed with an optical character recognition program executing on said multi-function peripheral.

14. The method of editing a document on an MFP of claim 10, wherein said reformatting said edited text file is performed with a reformatter driver executing on said multi-function peripheral.

15. The method of editing a document on an MFP of claim 9, wherein said producing an electronic text file further comprises selecting one or more pages of said document which have been scanned by said scanning unit and producing said electronic text file from the selected page or pages.

16. A system for editing a document on a multi-function peripheral (MFP), said system comprising:
means for scanning said document;
means for producing an electronic text file representing said document;
means for editing said text file at said MFP to produce an edited text file; and
means for printing said edited text file.

17. The system of editing a document on an MFP of claim 16, further comprising means for reformatting said edited text file prior to printing said edited text file.

18. The system of editing a document on an MFP of claim 16, further comprising means for adding text to said text file.

19. The system of editing a document on an MFP of claim 16, further comprising means for rearranging graphic elements of said document represented in said electronic text file.

20. The system of editing a document on an MFP of claim 15, wherein said means for producing an electronic text file comprise an optical character recognition program.

21. The system of editing a document on an MFP of claim 17, wherein said means for reformatting said edited text file comprise a reformatter driver.

22. The system of editing a document on an MFP of claim 16, wherein said means for producing an electronic text file further comprise means for identifying one or more selected pages of said document and producing said electronic text file from said selected page or pages.

23. A multi-function peripheral (MFP) comprising:
a processor; and
a data storage device;
wherein said data storage device stores computer-readable instructions which, when executed by said processor, cause said processor to:
access an electronic text file representing a document;
edit said text file in response to input from a user interface of said MFP to produce an edited text file; and
selectively print said edited text file.

24. The MFP of claim 23, wherein said instructions, when executed, further cause said processor to reformat said edited text file prior to printing said edited text file.

25. The MFP of claim 23, further comprising a scanning unit for scanning a hardcopy document into electronic data.

26. The MFP of claim 25, wherein said instructions further comprise an optical character recognition program that, when executed, further cause said processor to produce said electronic text file based on said electronic data from said scanning unit.

27. The MFP of claim 26, wherein said instructions, when executed, further cause said processor to:
receive user input selecting one or more pages of said document; and
produce said electronic text file based on the electronic data from said scanning unit that represents the selected page or pages.
